(19) United States
(12) Patent Application Publication
(10) Pub. No.: US 2005/0255831 A1
(43) Pub. Date: Nov. 17, 2005

(54) Radio communication system

(75) Inventors: Keiji Kato, Nagoya-shi (JP); Ikuro Adachi, Nagoya-shi (JP)

Correspondence Address: RANKIN, HILL, PORTER & CLARK LLP, 4080 ERIE STREET, WILLOUGHBY, OH, 44094-7836, US

(73) Assignee: RINNAI CORPORATION, Nagoya-shi (JP)

(21) Appl. No.: 11/122,672

(22) Filed: May 5, 2005

(30) Foreign Application Priority Data
May 13, 2004 (JP) 2004-144058

(51) Int. Cl. H04M 3/16; H04M 1/68; H04M 1/66; H04B 7/14

(52) U.S. Cl. 455/411; 455/410

(57) ABSTRACT

A radio communication system for registering an ID code of a communication partner in a transceiver easily and surely. In a first step, a slave set transmits “pairing application data” including a slave set ID to a master set. In a second step, the master set transmits “pairing reception data” including a master set ID and the slave set ID to the slave set. In a third step, the slave set transmits “first pairing selection data” including the slave set ID and the master set ID to the master set. In a fourth step, the master set transmits “second pairing selection data” including the master set ID and the slave set ID to the slave set. After the master set and the slave set recognize that processing for selecting communication partners is performed between the master set and the slave set according to the first to the fourth steps, in a fifth step, the slave set registers the master set ID of the master set and transmits “pairing completion data” to the master set. In a sixth step, the master set, which has received the “pairing completion data”, registers the slave set ID of the slave set.

### BACKGROUND OF THE INVENTION

1. Field of the Invention

The present invention relates to a system that performs data communication by radio among plural transceivers to which unique ID codes are allocated, and more particularly, to a radio communication system that executes processing in which the transceivers recognize and register the ID codes of the communication partners.

2. Description of the Related Art

As an example of a system for performing data communication by radio among plural transceivers, there is known a hot water supply system that is adapted to remotely control a water heater main body using a radio remote controller. In order to specify a communication partner and execute radio communication between a water heater main body and a radio remote controller, the hot water supply system performs processing for registering an ID code (a machine code) of the water heater main body in the radio remote controller and registering an ID code of the radio remote controller in the water heater main body (see, for example, Japanese Patent Application Laid-Open No. Hei 6-296290).

In such a hot water supply system, the ID code of the water heater main body is transmitted to the radio remote controller and registers and the ID code of the radio remote controller is transmitted to the water heater main body and registered according to switch operation of the water heater main body and the radio remote controller. The ID code of the water heater main body is displayed on a display section of the radio remote controller and a display section of the water heater main body. A worker installing the water heater confirms whether the ID codes of the water heater main body displayed on the display sections of the water heater main body and the radio remote controller coincide with each other. When the ID codes coincide with each other, the worker ends registration processing for the ID code according to special operation of the radio remote controller.

In the conventional hot water supply system described above, the water heater main body is required to include the display section for displaying the ID code. Thus, cost for the water heater main body increases because of cost for the display section. In addition, the worker installing the hot water supply system is required to perform troublesome work of confirming whether the ID code displayed on the radio remote controller and the ID code displayed on the water heater main body coincide with each other.

### SUMMARY OF THE INVENTION

Therefore, in view of such a background, it is an object of the invention to provide a radio communication system that can register an ID code of a communication partner in a transceiver easily and surely.

The invention has been devised in order to attain the object. The invention relates to an improvement of a radio communication system in which data communication is performed by radio between a first transceiver and a second transceiver, to which unique ID codes are allocated, and the first transceiver and the second transceiver register ID codes of communication partners, include own ID codes in data when transmitting data, and specify the communication partners from ID codes included in data when receiving the data.

In order to mutually recognize and register ID codes between a pair of the first transceiver and the second transceiver in which ID codes of communication partners are not registered, the radio communication system executes pairing processing including: a first step in which the first transceiver transmits pairing application data including an own ID code; a second step in which the second transceiver, which has received the pairing application data, transmits pairing reception data including an own ID code and the ID code of the first transceiver acquired from the pairing application data; a third step in which the first transceiver, which has received the pairing reception data, transmits first pairing selection data including the own ID code and the ID code of the second transceiver acquired from the pairing reception data; a fourth step in which the second transceiver, which has received the first pairing selection data, transmits second pairing selection data including the own ID code; a fifth step in which the first transceiver, which has received the second pairing selection data, registers the ID code of the second transceiver as an ID code of a communication partner and transmits pairing completion data including the own ID code; and a sixth step in which the second transceiver, which has received the pairing completion data, registers the ID code of the first transceiver as an ID code of a communication partner.

According to the invention described above, at a point when the second transceiver receives the first pairing selection data in the third step of the pairing processing, the first transceiver can recognize that the second transceiver has selected the first transceiver as a communication partner. In addition, at a point when the second transceiver receives the second pairing selection data in the fourth step, the second transceiver recognizes that the first transceiver has selected the second transceiver as a communication partner.

In this way, the first transceiver and the second transceiver each recognize that the communication partner has selected each other as the communication partner and, then, the first transceiver registers the second transceiver as a communication partner in the fourth step and the second transceiver registers the first transceiver as a communication partner in the fifth step. As a result, each of the first transceiver and the second transceiver can confirm that the communication partner has selected each other as the communication partner and, then, registers ID code of the communication partner. Consequently, the first transceiver and the second transceiver can register the ID codes of the communication partners surely and work for confirming the ID codes by a worker installing a water heater is not required. In addition, it is unnecessary to provide display means, which displays an ID code for confirmation, in the first transceiver and the second transceiver.

The second transceiver performs data communication by radio between each of a plurality of the first transceivers and executes the pairing processing individually between each of the plural first transceivers. As a result, the second transceiver registers ID codes of the respective first transceivers and the respective first transceivers register the ID code of the second transceiver.

According to the invention described above, the second transceiver and the plural first transceiver execute the pairing processing individually, whereby the ID codes of the respective first transceivers are registered in the second transceiver and the ID code of the second transceiver in the respective first transceiver. This makes it possible to perform data communication by radio between the second transceiver and the respective first transceiver.

In addition, the radio communication system includes: informing means; and pairing end informing means for informing a user of end of the pairing processing using the informing means when the pairing processing ends.

According to the invention described above, a worker, who executes the pairing processing, can confirm that the pairing processing ends by confirming the information by the informing means.

### BRIEF DESCRIPTION OF THE DRAWINGS

In the accompanying drawings:

FIG. 1 is an overall diagram of a hot water supply system (a radio communication system of the invention);

FIG. 2A is an external view of a slave set shown in FIG. 1;

FIG. 2B is an external view of a master set shown in FIG. 1;

FIG. 3A is a diagram of the master set shown in FIG. 1;

FIG. 3B is a diagram of the slave set shown in FIG. 1;

FIG. 4 is a flowchart on a master set side of pairing processing;

FIG. 5 is a flowchart on a slave set side of the pairing processing; and

FIG. 6 is a diagram explaining transmission and reception states between the master set and the slave set at the time when the pairing processing is executed.

### DETAILED DESCRIPTION OF THE PREFERRED EMBODIMENTS

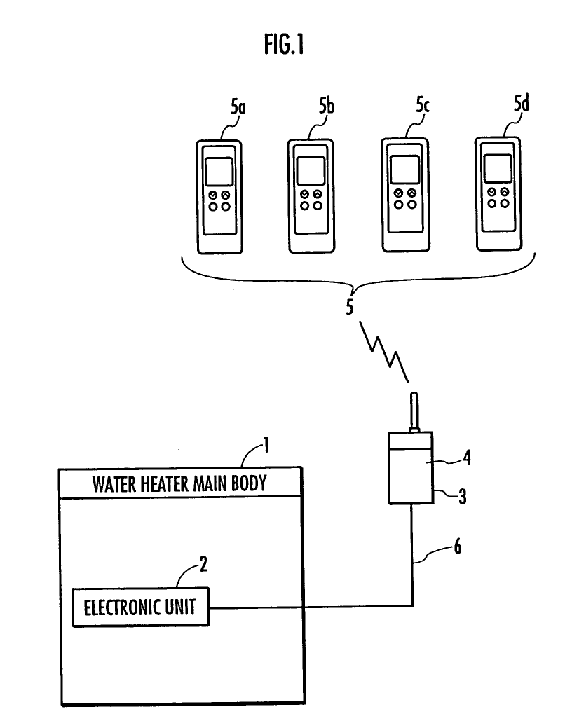

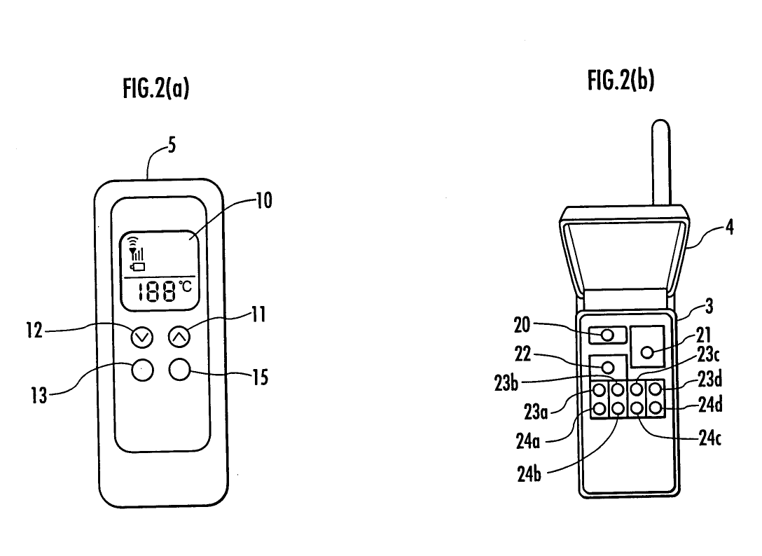

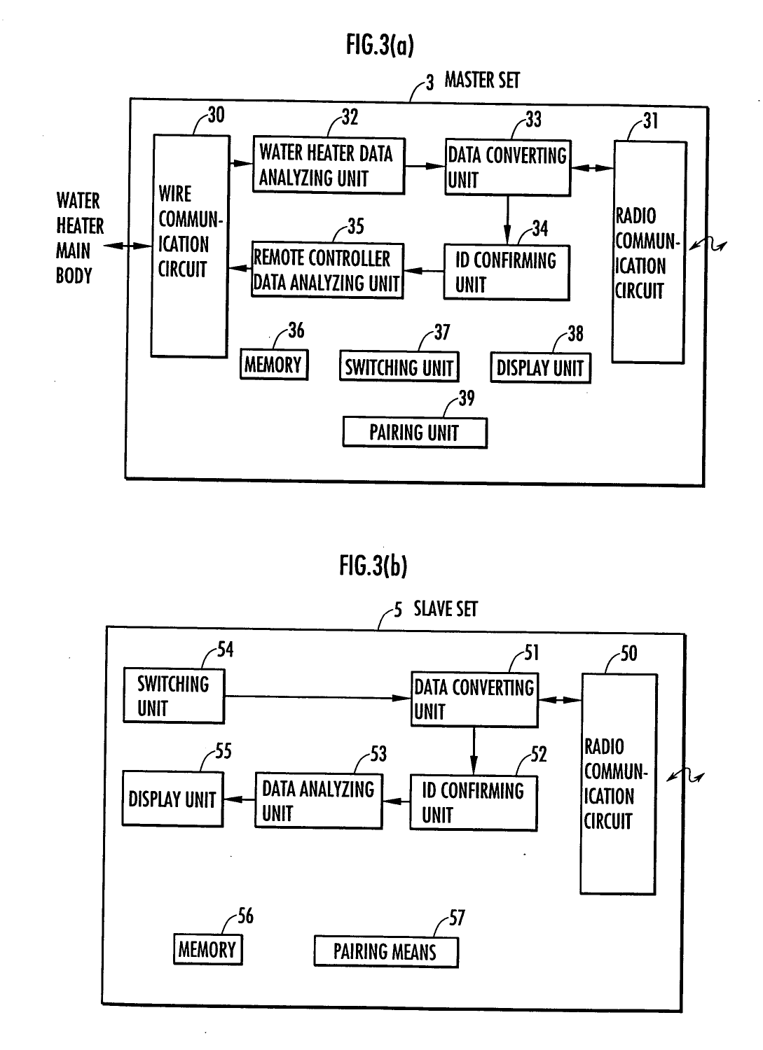

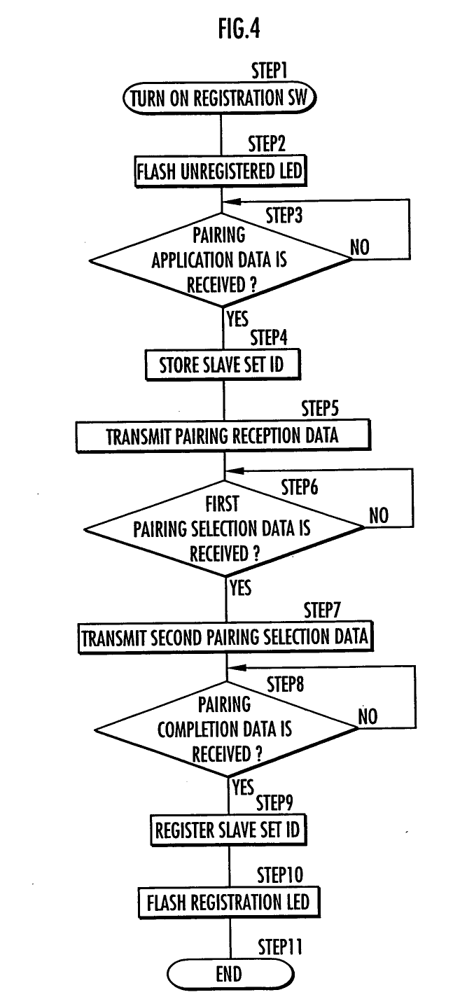

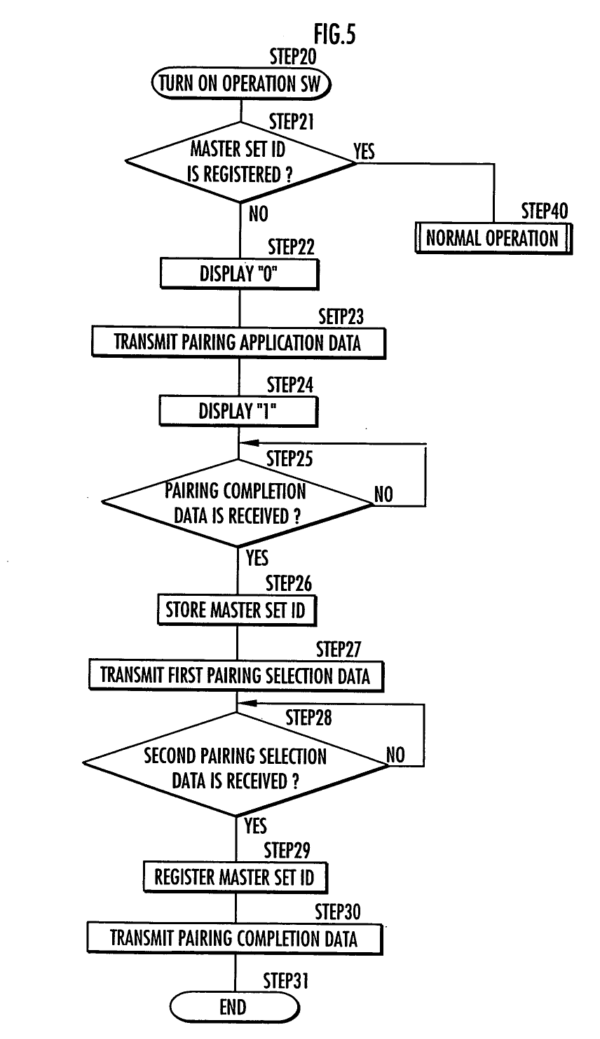

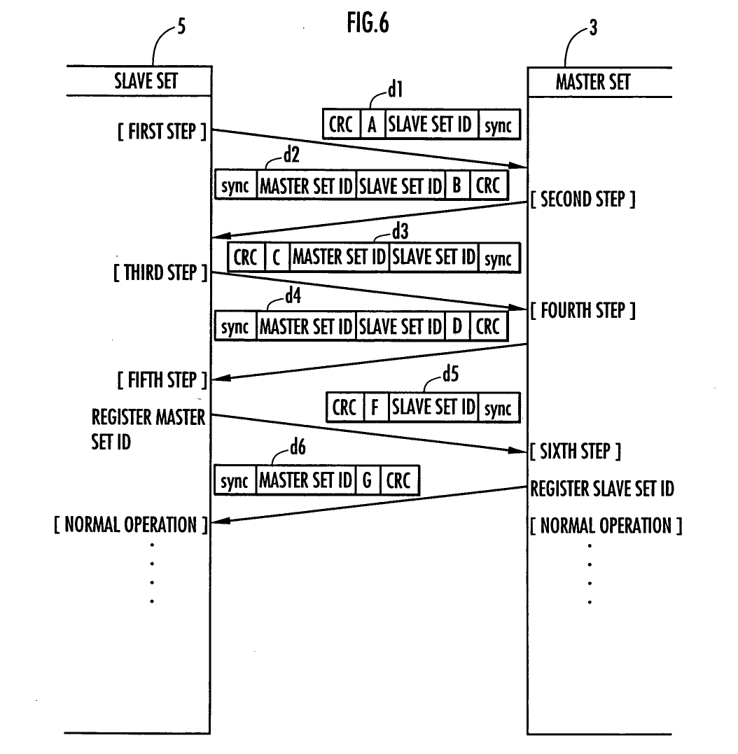

An embodiment of the invention will be hereinafter explained with reference to the accompanying drawings. FIG. 1 is an overall diagram of a hot water supply system serving as a radio communication system of the invention. FIG. 2A is an external view of a slave set shown in FIG. 1. FIG. 2B is an external view of a master set shown in FIG. 1. FIG. 3A is a diagram of the master set shown in FIG. 1. FIG. 3B is a diagram of the slave set shown in FIG. 1. FIG. 4 is a flowchart on a master set side of pairing processing. FIG. 5 is a flowchart on a slave set side of the pairing processing. FIG. 6 is a diagram explaining transmission and reception states of data between the master set and the slave set at the time when the pairing processing is executed.

Referring to FIG. 1, a water heater main body 1 is controlled by an electronic unit 2 including a microcomputer and a memory. The electronic unit 2 is connected to a master set 3 (corresponding to a second transceiver of the invention) by a communication cable 6 so as to be capable of communicating with each other. The master set 3 performs data communication by radio with slave sets 5 (5a to 5d, corresponding to first transceivers of the invention) that are radio remote controllers for remotely operating the water heater 1. Note that unique ID codes are allocated to the master set 3 and the slave sets 5 in advance.

Next, referring to FIG. 2A, the slave set 5 includes a liquid crystal panel 10 for displaying set temperature for hot water supply and the like, an operation switch 15 for switching the water heater main body 1 to a “hot water supply operation state” in which hot water supply is possible and a “hot water supply standby state” in which hot water supply is impossible, an UP switch 11 and a DOWN switch 12 for setting hot water supply temperature, and a priority switch 13 for setting the slave set 5 in a priority state in which setting for hot water supply temperature for the slave set 5 is performed preferentially over the other slave sets.

Referring to FIG. 2B, the master set 3 includes a cover 4, a registration switch 22 for instructing execution of “pairing processing” (details will be described later) for performing notification and registration of ID codes between the master set 3 and the slave set 5, and an upper limit temperature switch 21 for switching an upper limit value of settable hot water supply temperature between two kinds of temperature (e.g., 60° C. and 70° C.) set in advance.

The master set 3 is capable of performing data communication with the four slave sets 5 (5a to 5d) at the maximum. In order to apply registration of ID codes and release of the registration to the four slave sets 5 by “pairing processing” individually, the master set 3 includes registration LEDs 23 (23a to 23d) and registration clear switches 24 (24a to 24d) for the four slave sets 5. The maser set 3 also includes an operation LED 20 for confirming an operation state (operating, stopped, occurrence of an error, etc.) of the water heater main body 1.

Next, referring to FIG. 3A, the master set 3 includes a wire communication circuit 30 that performs data communication by wire with the water heater main body 1 (see FIG. 1), a radio communication circuit 31 that performs data communication by radio with the slave set 5, a water heater data analyzing unit 32 that analyzes data received from the water heater main body 1, a data converting unit 33 that performs conversion of data formats of wire/radio, an ID confirming unit that confirms an ID code included in received data and specifies the slave set 5 that is a communication partner, a remote controller data analyzing unit 35 that analyzes data received from the slave set 5, a memory 36 that stores an ID code of the master set 3, an ID code of the slave set 5, and the like, a switching unit 37 including the various switches shown in FIG. 2B and a switching interface circuit, a display unit 38 including the various LEDs shown in FIG. 2B and a display interface circuit, and pairing means 39 that executes the “pairing processing” between the master set 3 and the slave set 5.

Referring to FIG. 3B, the slave set 5 includes a radio communication circuit 50 that performs data communication by radio with the master set 3, a data converting unit 51 that converts data formats of wire/radio, an ID confirming unit 52 that confirms an ID code included in received data and specifies the master set 3 that is a communication partner, a data analyzing unit 53 that analyzes data received from the master set 3, a switching unit 54 including the various switches shown in FIG. 2A and a switching interface circuit, a display unit 55 including the LCD panel 10 shown in FIG. 2A and a display interface circuit, a memory 56 that stores an ID code of the slave set 5, an ID code of the master set 3, and the like, and pairing means 57 that executes the “pairing processing” between the slave set 5 and the master set 3.

Next, with reference to FIGS. 4 to 6, a procedure for executing the “pairing processing” between the master set 3 and the slave 5 to register an ID code of the slave set 5 in the master set 3 and register an ID code of the master set 3 in the slave set 5 will be explained.

First, FIG. 4 is a flowchart of the “pairing processing” on the master set 3 side. When a worker installing a hot water supply system operates the registration switch 22 (see FIG. 2B) of themaster set 3 and the registration switch 22 is changed over from an off state to an on state, the pairing means 39 of the master set 3 proceeds from STEP 1 to STEP 2 to start the “pairing processing”. Then, in the next STEP 2, the pairing means 39 flashes the LED 23 corresponding to the slave set 5, an ID code of which is not registered, among the registration LED 23a to 23d. In STEP 3, the pairing means 39 stands by for reception of “pairing application data” to be transmitted from the slave set 5.

When the “pairing application data” is received in STEP 2, the pairing means 39 proceeds to STEP 4. In STEP 4, the pairing means 39 stores an ID code of the slave set 5 acquired by the ID confirming unit 34 (see FIG. 3A) in the memory 36. In the next STEP 5, the pairing means 39 transmits “pairing reception data” including an own ID code and the ID code of the slave set 5 to the slave set 5. Note that STEP 3 to STEP 5 correspond to the second step of the invention.

In the next STEP 6, the pairing means 39 stands by for “first pairing selection data” including the ID code of the slave set 5 and the ID code of the master set 3 that is transmitted from the slave set 5. Here, when the master set 3 receives the “first pairing selection data”, it is possible to judge that the slave set 5 has recognized the ID code of the master set 3 and selected the master set 3 as a communication partner.

Thus, when the “first pairing selection data” is received in STEP 6, the pairing means 39 proceeds to STEP 7. In order to notify the slave set 5 that the master set 3 has selected the slave set 5 as a communication partner, the pairing means 39 transmits “second pairing selection data” including the ID code of the master set 3 and the ID code of the slave set 5 to the slave set 5. Note that STEP 6 to STEP 7 correspond to the fourth step of the invention.

In the next STEP 8, the pairing means 39 stands by for “pairing completion data” including the ID code of the slave set 5 that is sent from the slave set 5. Here, when the master set 3 receives the “pairing completion data”, the pairing means 39 can judge that registration of the ID code of the master set 3 is completed on the slave set 5 side.

Thus, when the “pairing completion data” is received in STEP 8, the pairing means 39 proceeds to STEP 9, determines the slave set 5 as a communication partner, and registers the ID code of the slave set 5. In addition, in the subsequent STEP 10, the pairing means 39 flashes the registration LED 23 (any one of the registration LEDs 23a to 23d) corresponding to the registered slave set 5 and proceeds to STEP 11 to end the “pairing processing”.

Note that the registration LED 23 corresponds to the informing means of the invention. Processing for flashing the registration LED 23 in STEP 10 corresponds to the pairing end informing means of the invention.

Next, FIG. 5 is a flowchart on the slave set 5 side. When the worker operates the operation switch 15 of the slave set 5 (see FIG. 2A) and the operation switch 15 is changed over from an off state to an on state, the slave set 5 proceeds from STEP 20 to STEP 21 and judges whether an ID code of the master set 3, which is a communication partner, is registered in the memory 56 (see FIG. 3B). When the ID code of the master set 3 is already registered, the slave set 5 branches the processing to STEP 40 and executes “normal operation” for detecting an operation state of the respective switches (see FIG. 2A) and transmitting a control signal to the master set 3.

On the other hand, when the ID code of the master set 3 is not registered yet in STEP 21, the slave set 5 proceeds to STEP 22. The pairing means 57 (see FIG. 3B) of the slave set 5 executes “pairing processing” in STEP 22 and subsequent steps.

First, in STEP 22, the pairing means 57 displays “0” on the LCD panel 10 (see FIG. 2A) and informs the worker that the ID code of the master set 3 is unregistered. Then, in the next STEP 23, the pairing means 57 transmits “pairing application data” including an ID code of the slave set 5 to the master set 3. In STEP 24, the pairing means 57 displays “1” on the LCD panel 10 and informs the worker that the “pairing application data” is transmitted. Note that STEP 23 corresponds to the first step of the invention.

In the subsequent STEP 25, the pairing means 57 stands by for reception of “pairing reception data” including the ID code of the master set 3 and the ID code of the slave set 5 that is transmitted from the master set 3. Here, when the “pairing reception data” is received, the pairing means 57 can judge that the master set 3 has recognized the ID code of the slave set 5.

When the “pairing reception data” is received in STEP 5, the pairing means 57 proceeds to STEP 26. In order to notify the master set 3 that the slave set 5 has selected the master set 3 as a communication partner, the pairing means 57 transmits “first pairing selection data” including the ID code of the slave set 5 and the ID code of the master set 3 to the master set 3. Note that STEP 25 to STEP 27 correspond to the third step of the invention.

In the next STEP 28, the pairing means 57 stands by for “second pairing selection data” including the ID code of the master set 3 and the ID code of the slave set 5 that is transmitted from the master set 3. Here, when the slave set 5 receives the “second pairing selection data”, the pairing means 57 can judge that the master set 3 has selected the slave set 5 as a communication partner. The slave set 5 and the master set 3 selected each other as communication partner.

Thus, when the “second pairing selection data” is received in STEP 28, the pairing means 57 proceeds to STEP 29 and registers the ID code of the master set 3. In addition, in the subsequent STEP 30, the pairing means 57 transmits “pairing completion data” including the ID code of the slave set 5 to the master set 3 and proceeds to STEP 31 to end the “pairing processing”.

FIG. 6 is a diagram showing transmission and reception states of data between the slave set 5 and the master set 3 at the time when the “pairing processing” is executed according to the flowcharts in FIGS. 4 and 5. First, “pairing application data” d1, which includes an ID code of the slave set 5 (a slave set ID in the figure) and A information (A in the figure) notifying application for pairing, is transmitted from the slave set 5 to the master set 3 (first step). Note that data for synchronization (sync in the figure) are added to tops of respective data transmitted and received between the master set 3 and the slave set 5. CRC codes for error correction (CRC in the figure) are added to tails of the data.

Next, “pairing reception data” d2, which includes an ID code of the master set 3 (a master set ID in the figure), the slave set ID, and B information (B in the figure) notifying reception of pairing, is transmitted from the master set 3, which has received the “pairing application data” d1, to the slave set 5 (second step).

Next, “first pairing selection data” d3, which includes the slave set ID, the master set ID, and C information (C in the figure) notifying the master set 3 that the slave set 5 has selected the master set 3 as a communication partner, is transmitted from the slave set 5, which has received the “pairing reception data” d2, to the master set 3 (third step).

Next, “second pairing selection data” d4, which includes the master set ID, the slave set ID, and D information (D in the figure) notifying the slave set 5 that the master set 3 has selected the slave set 5 as a communication partner, is transmitted from the master set 3, which has received the “first pairing selection data” d3, to the slave set 5 (fourth step).

Here, at a stage when the slave set 5 receives the “second pairing selection data” d4, the slave set 5 and the master set 3 recognize that the slave set 5 and the master set 3 selected each other as communication partner. Thus, the slave set 5 registers the ID code of the master set 3 and transmits “pairing completion data” d5 notifying the master set 3 that registration of the ID code of the master set 3 (the master set ID) is completed to the master set 3 (fifth step).

Then, according to reception of the “pairing completion data” d5, the master set 3, which has recognized completion of the registration of the ID code of the master set 3 on the slave set 5 side, registers the ID code of the slave set 5 (the slave set ID) (sixth step).

In this way, according to the first to the sixth steps, the registration of the ID code of the master set 3 in the slave set 5 is completed and the registration of the ID code of the slave set 5 in the master set 3 is completed. Consequently, thereafter, when the master set 3 transmits data including a master set ID, which is an own ID of the master set 3, to the slave et 5, the slave set 5 can recognize the master ID and specify the master set 3 as a communication partner. In addition, when the slave set 5 transmits data including a slave set ID, which is an own ID code of the slave set 5, to the master set 3, the master set 3 can recognize the slave set ID and specify the slave set 5 as a communication partner.

Note that, when plural slave sets 5 are used, the “pairing processing” explained above only has to be executed between the respective slave sets 5 and the master set 3.

In this embodiment, the hot water supply system, which remotely controls the water heater main body with the radio remote controller, is described as the radio communication system of the invention. However, it is possible to apply the invention to any radio communication system as long as the radio communication system performs processing for registering ID codes among plural transceivers.

1. A radio communication system in which data communication is performed by radio between a first transceiver and a second transceiver, to which unique ID codes are allocated, and the first transceiver and the second transceiver register ID codes of communication partners, include own ID codes in data when transmitting data, and specify the communication partners from ID codes included in data when receiving the data, wherein
in order to mutually recognize and register ID codes between a pair of the first transceiver and the second transceiver in which ID codes of communication partners are not registered, the radio communication system executes pairing processing comprising:
a first step in which the first transceiver transmits pairing application data including an own ID code;
a second step in which the second transceiver, which has received the pairing application data, transmits pairing reception data including an own ID code and the ID code of the first transceiver acquired from the pairing application data;
a third step in which the first transceiver, which has received the pairing reception data, transmits first pairing selection data including the own ID code and the ID code of the second transceiver acquired from the pairing reception data;
a fourth step in which the second transceiver, which has received the first pairing selection data, transmits second pairing selection data including the own ID code;
a fifth step in which the first transceiver, which has received the second pairing selection data, registers the ID code of the second transceiver as an ID code of a communication partner and transmits pairing completion data including the own ID code; and
a sixth step in which the second transceiver, which has received the pairing completion data, registers the ID code of the first transceiver as an ID code of a communication partner.

2. The radio communication system according to claim 1, wherein the second transceiver performs data communication by radio between each of a plurality of the first transceivers and executes the pairing processing individually between each of the plural first transceivers, whereby the second transceiver registers ID codes of the respective first transceivers and the respective first transceivers register the ID code of the second transceiver.

3. The radio communication system according to claim 1, further comprising:
informing means; and
pairing end informing means for informing a user of end of the pairing processing using the informing means when the pairing processing ends.

4. The radio communication system according to claim 2, further comprising:
informing means; and
pairing end informing means for informing a user of end of the pairing processing using the informing means when the pairing processing ends.
